(19) United States
(12) Patent Application Publication
(10) Pub. No.: US 2025/0088069 A1
(43) Pub. Date: Mar. 13, 2025

(54) MOTOR

(71) Applicant: LG INNOTEK CO., LTD., Seoul (KR)

(72) Inventor: Chang Hyun PARK, Seoul (KR)

(73) Assignee: LG INNOTEK CO., LTD., Seoul (KR)

(21) Appl. No.: 18/723,824

(22) PCT Filed: Dec. 21, 2022
(86) PCT No.: PCT/KR2022/020950

§ 371 Date: Jun. 24, 2024

(30) Foreign Application Priority Data
Dec. 22, 2021 (KR) 10-2021-0185011

(51) Int. Cl. H02K 7/00; H02K 7/08

(52) U.S. Cl. CPC H02K 7/003; H02K 7/083

(57) ABSTRACT

The present invention may provide a motor comprising: a shaft; a rotor coupled to the shaft; a stator arranged to correspond to the rotor; and a bearing supporting the shaft, wherein the shaft includes a first region overlapping the bearing in the direction perpendicular to the axial direction of the shaft, the first region includes a first section and a second section, and the outer diameter of the first section is greater than the outer diameter of the second section.

### CROSS REFERENCE TO RELATED APPLICATIONS

This application is the National Phase of PCT International Application No. PCT/KR2022/020950, filed on Dec. 21, 2022, which claims priority under 35 U.S.C. 119(a) to Patent Application No. 10-2021-0185011, filed in the Republic of Korea on Dec. 22, 2021, all of which are hereby expressly incorporated by reference into the present application.

### TECHNICAL FIELD

Embodiments relate to a motor.

### BACKGROUND ART

A motor includes a shaft, a rotor, and a stator. The rotor and the stator are included in a housing. The stator may include a stator core, and a coil wound around the stator core.

The shaft may be a hollow member. A bearing supporting the shaft may support each of one side and the other side of the shaft. The bearing supporting the one side of the shaft may support the shaft in an axial direction as well as a radial direction, and the bearing supporting the other side of the shaft may guide the rotation of the shaft by supporting the shaft in the radial direction rather than supporting an axial load.

When the shaft and the bearing are assembled, the shaft and the bearing are assembled with a tolerance between the shaft and the bearing. The tolerance is for smoothly assembling the shaft and the bearing.

However, when the tolerance is too large, there is a problem of the occurrence of noise. On the other hand, when the tolerance is too small, there is a problem that a friction torque increases greatly.

### DISCLOSURE

### Technical Problem

Therefore, embodiments are directed to solving the above problems and are directed to providing a motor in which, when a shaft and a bearing are assembled, noise can be reduced, and assemblability of a shaft and a bearing can be improved.

The object of the present invention is not limited to the above-described object, and other objects that are not mentioned will be able to be clearly understood by those skilled in the art from the following description.

### Technical Solution

A motor for achieving the object may provide a motor comprising a shaft with a hollow shape to form a space inside, a rotor coupled to the shaft, a stator disposed to correspond to the rotor and a first bearing configured to support the shaft, wherein the shaft includes a first region overlapping with the first bearing in a radial direction and the first region includes a second section including one end of the shaft and a first section extending along the axial direction from the second section, wherein the radial thickness of the second section is formed to be smaller than the radial thickness of the first section to form a space between the second section and the first bearing.

An inner diameter of the first section may be equal to an inner diameter of the second section.

An axial length of the second section may be in the range of 40% to 60% of an axial length of the first region.

The second section may include a 2-1 section and a 2-2 section partitioned in the axial direction, and an outer diameter of the 2-2 section is greater than an outer diameter of the 2-1 section.

The 2-1 section may be connected to an end of the shaft.

An axial length of the first section is greater than an axial length of the second section.

The axial length of the second section is in the range of 0.67 to 1.0 times the axial length of the first section.

A motor further comprise a second bearing supporting the other end of the shaft, wherein the inner diameter of the first bearing is greater than the inner diameter of the second bearing.

### Advantageous Effects

According to the embodiments, it has the advantage of preventing noise and vibration between the shaft and bearing and secure the assemblability of the shaft and the bearing.

According to the embodiments, by reducing the outer diameter of the partial region of the shaft corresponding to the bearing, it is possible to greatly design the tolerance of the shaft and the bearing, thereby greatly reducing the defects of the product.

### DESCRIPTION OF DRAWINGS

FIG. 1 is a view showing a motor according to a first embodiment.

FIG. 2 is an enlarged view of the other side end of a shaft.

FIG. 3 is a view showing an outer diameter of a first section and an outer diameter of a second section of the shaft.

FIG. 4 is a view showing a radial thickness of the first section and a radial thickness of the second section of the shaft.

FIG. 5 is a view showing an inner diameter of the first section and an inner diameter of the second section of the shaft.

FIG. 6 is a side cross-sectional view of the shaft coupled to a rotor.

FIG. 7 is a view showing a shaft including a first region according to a second embodiment.

FIG. 8 is a view showing a shaft including a first region according to a third embodiment.

### MODE FOR INVENTION

A direction parallel to a longitudinal direction (vertical direction) of a shaft is referred to as an axial direction, a direction perpendicular to the axial direction about the shaft is referred to as a radial direction, and a direction along a circle having a radial radius about the shaft is referred to as a perimetric direction.

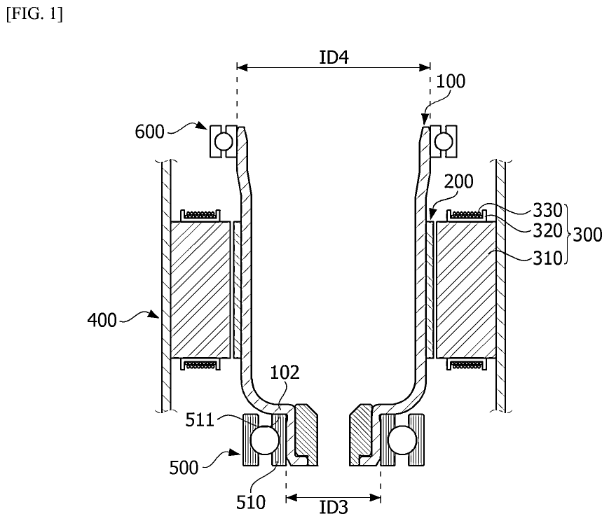

FIG. 1 is a view showing a motor according to a first embodiment.

Referring to FIG. 1, the motor according to the first embodiment may include a shaft 100, a rotor 200, a stator 300, a housing 400, a first bearing 500, and a second bearing 600. Hereinafter, the inside indicates a direction from the housing 400 toward the shaft 100, which is the center of the motor, and the outside indicates a direction opposite to the inside, which is a direction from the shaft 100 to the housing 400. In addition, a radial direction below is a direction with respect to the axial center of the shaft 100.

The shaft 100 may be coupled to the rotor 200. When electromagnetic interaction occurs between the rotor 200 and the stator 300 through current supply, the rotor 200 rotates, and the shaft 100 rotates in conjunction with the rotation of the rotor 400. The shaft 100 may be a hollow member. An axis of an external device may enter the shaft 100.

The rotor 200 is rotated by the electromagnetic interaction with the stator 300. The rotor 200 may be disposed inside the stator 300. The rotor 200 may be a magnet.

The stator 300 is disposed outside the rotor 200. The stator 300 may include a stator core 310, an insulator 320 mounted on the stator core 310, and a coil 330. The coil 330 may be wound around the insulator 320. The insulator 320 is disposed between the coil 330 and the stator core 310 to electrically insulate the stator core 310 and the coil 330. The coil 330 causes the electrical interaction with a magnet of the rotor 200.

The stator 300 and the rotor 200 are disposed inside the housing 400.

The first bearing 500 and the second bearing 600 are each fixed to the housing 400 to rotatably support the shaft 100.

The first bearing 500 is disposed at one side of the shaft 100 with respect to the axial direction. The second bearing 600 is disposed at the other side of the shaft 100 with respect to the axial direction. An inner diameter ID4 of the second bearing 600 is formed to be greater than an inner diameter ID3 of the first bearing 500.

The shaft 100 may include a stepped surface 102. One surface 511 of an inner ring 510 of the first bearing 500 may be in contact with the stepped surface 102. The first bearing 500 may support the one side of the shaft 100 not only in the radial direction but also in the axial direction.

The second bearing 600 supports the other side of the shaft 100 in the radial direction. The second bearing 600 is disposed not to overlap the shaft 100 in the axial direction.

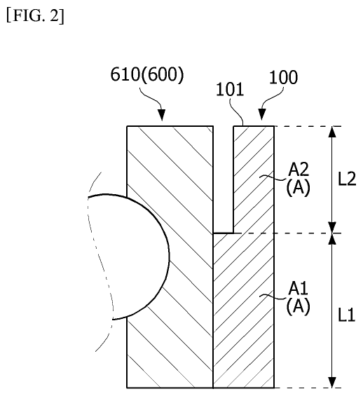

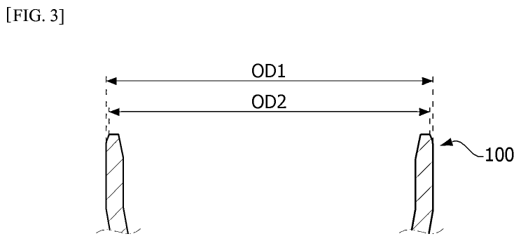

FIG. 2 is an enlarged view of the other side end 101 of the shaft 100, and FIG. 3 is a view showing an outer diameter OD1 of a first section A1 and an outer diameter OD2 of a second section A2 of the shaft 100.

Referring to FIG. 2, the shaft 100 includes a first region A. The first region A is defined as a partial region of the shaft 100 that overlaps with the second bearing 600 in a direction perpendicular to the axial direction.

The first region A may include the first section A1 and the second section A2. An outer diameter OD′ of the first section A1 is formed to be greater than the outer diameter OD2 of the second section A2. The first section A1 and the second section A2 may be partitioned in the axial direction and consecutively disposed in the axial direction.

The second section A2 may be located at the other side of the shaft 100, and the first section A1 may be located lower side of the second section A2 in the axial direction. The second section A2 includes the other side end 101 of the shaft 100.

The first section A1 is a region in contact with an inner ring 610 of the second bearing 600, and the second section A2 is a region spaced apart from the inner ring 610 of the second bearing 600, and is a section in which the second bearing 600 is smoothly assembled to the shaft 100 and a tolerance between the second bearing 600 and the shaft 100 is secured.

The second section A2 may have the same outer diameter OD2 in the axial direction.

An axial length L2 of the second section A2 may be in the range of 0.67 to 1.5 times an axial length L1 of the first section A1. That is, the axial length L1 of the first section A1 may be in the range of 40% to 60% of an axial length (L1+L2) of the first region A.

For example, with respect to the axial direction, the axial length L1 of the first section A1 may be greater than the axial length L2 of the second section A2. For example, the axial length L2 of the second section A2 may be in the range of 0.67 to 1.0 times the axial length L1 of the first section A1. When the axial length L2 of the second section A2 is smaller than 0.67 times the axial length L1 of the first section A1, it is difficult to secure a sufficient tolerance between the second bearing 600 and the shaft 100, thereby degrading the assemblability of the second bearing 600 and the shaft 100, and thus defects highly likely occur. When the axial length L1 of the first section A1 is greater than 1.0 times the axial length L2 of the second section A2, noise and vibration can be further reduced.

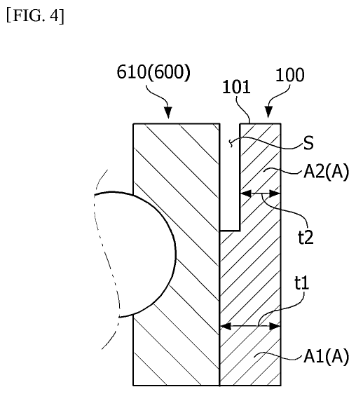

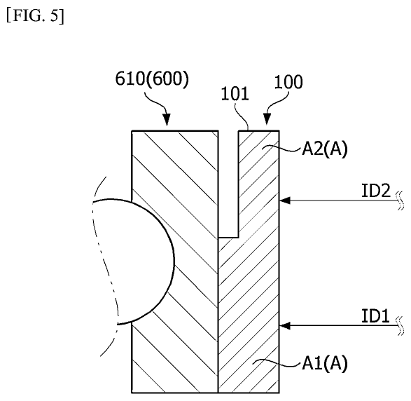

FIG. 4 is a view showing a radial thickness t1 of the first section A1 and a radial thickness t2 of the second section A2 of the shaft 100, and FIG. 5 is a view showing an inner diameter ID1 of the first section A1 and an inner diameter ID2 of the second section A2 of the shaft 100.

Referring to FIGS. 1 and 4, the radial thickness t2 of the second section A2 is formed to be smaller than the radial thickness t1 of the first section A1. The second section A2 of the shaft 100 forms a space S with the inner ring 610 of the second bearing 600 in the radial direction. Since the second bearing 600 has a greater inner diameter than the first bearing 500, there is a problem that it is difficult to manage the tolerance. Due to the space S, there is an advantage in that the upper and lower limits of the allowable tolerance for dimensions of the second bearing 600 or the upper and lower limits of the allowable tolerance for dimension of the shaft 100 can be increased.

Referring to FIG. 5, the inner diameter ID1 of the first section A1 may be equal to the inner diameter ID2 of the second section A2.

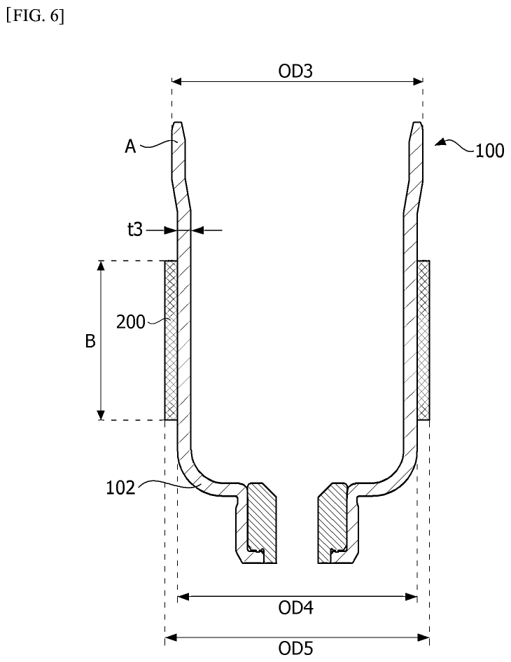

FIG. 6 is a side cross-sectional view of the shaft 100 to which the rotor 200 is coupled.

Referring to FIGS. 1 and 6, the rotor 200 is attached to an outer perimetric surface of the shaft 100. The shaft 100 includes a second region B in contact with the rotor 200. The second region B may be disposed between the stepped surface 102 and the first region A in the axial direction.

An outer diameter OD3 of the first region A is formed to be greater than an outer diameter OD4 of the second region B. Here, the outer diameter OD3 of the first region A may correspond to the outer diameter OD1 of the first section A1 or the outer diameter OD2 of the second section A2.

Meanwhile, a radial thickness t3 of the remaining region of the shaft 100 excluding the first region A may be constant in the axial direction.

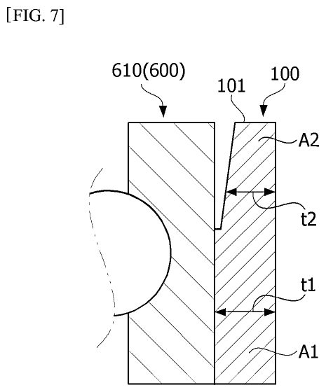

FIG. 7 is a view showing the shaft 100 including the first region A according to a second embodiment.

Referring to FIG. 7, the second section A2 of the first region A according to the second embodiment may be formed to reduce the outer diameter toward the other side end 101 of the shaft 100 in the axial direction. Therefore, the second section A2 may be formed to have an increased separation distance from the second bearing 600 in the radial direction toward the one side end 101 of the shaft 100.

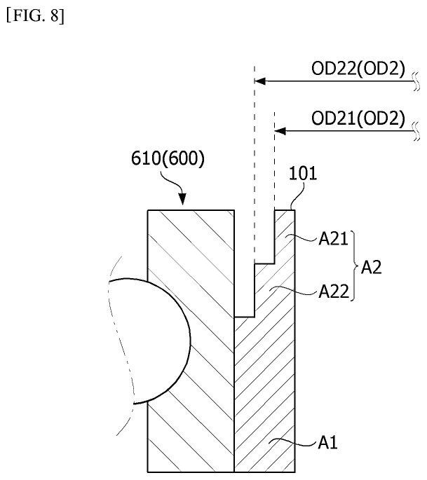

FIG. 8 is a view showing the shaft 100 including the first region A according to a third embodiment.

Referring to FIG. 8, the second section A2 of the first region A according to another modified example may include a 2-1 section A21 and a 2-2 section A22. The 2-1 section A21 and the 2-2 section A22 are partitioned in the axial direction. An outer diameter OD22 of the 2-2 section A22 may be greater than an outer diameter OD21 of the 2-1 section A21.

Therefore, the 2-1 section A21 may form a greater separation space from the inner ring 610 of the second bearing 600 than the 2-2 section A22. The 2-1 section A21 includes the one side end 101 of the shaft 100.

The outer diameter OD21 of the 2-1 section A21 may be the same in the axial direction. In addition, the 2-2 outer diameter OD22 may also be the same in the axial direction.

The above-described embodiments may be used in various devices such as devices for a vehicle or home appliance.

1-10. (canceled)

11. A motor comprising:
a shaft with a hollow shape to form a space inside;
a rotor coupled to the shaft;
a stator disposed to correspond to the rotor; and
a first bearing configured to support the shaft,
wherein the shaft includes a first region overlapping with the first bearing in a radial direction,
wherein the first region includes a second section including one end of the shaft and a first section extending along the axial direction from the second section, and
wherein the radial thickness of the second section is formed to be smaller than the radial thickness of the first section to form a space between the second section and the first bearing.

12. The motor of claim 11, wherein an inner diameter of the first section is equal to an inner diameter of the second section.

13. The motor of claim 11, wherein an axial length of the second section is in the range of 40% to 60% of an axial length of the first region.

14. The motor of claim 11, wherein the second section includes a 2-1 section and a 2-2 section partitioned in the axial direction, and
wherein an outer diameter of the 2-2 section is greater than an outer diameter of the 2-1 section.

15. The motor of claim 14, wherein the 2-1 section is connected to an end of the shaft.

16. The motor of claim 11, wherein an axial length of the first section is greater than an axial length of the second section.

17. The motor of claim 16, wherein the axial length of the second section is in the range of 0.67 to 1.0 times the axial length of the first section.

18. The motor of claim 11, further comprising a second bearing supporting the other end of the shaft,
wherein the inner diameter of the first bearing is greater than the inner diameter of the second bearing.
